(19) United States
(12) Patent Application Publication
(10) Pub. No.: US 2013/0184182 A1
(43) Pub. Date: Jul. 18, 2013

(54) BIO CHIP

(71) Applicants: Dong Woo LEE, Suwon (KR); Jeong Suong Yang, Yongin (KR); Bo Sung Ku, Suwon (KR)

(72) Inventors: Dong Woo LEE, Suwon (KR); Jeong Suong Yang, Yongin (KR); Bo Sung Ku, Suwon (KR)

(73) Assignee: SAMSUNG ELECTRO-MECHANICS CO., LTD.

(21) Appl. No.: 13/403,391

(22) Filed: Feb. 23, 2012

(30) Foreign Application Priority Data
Jan. 17, 2012 (KR) 10-2012-0005142

(51) Int. Cl. C40B 40/00

(52) U.S. Cl. 506/13

(57) ABSTRACT

There is provided a bio-chip including a first substrate including a plurality of micro-pillars protruded from one surface thereof to a predetermined height and having a biomaterial adhered to protruded surfaces of the plurality of micro-pillars, wherein the first substrate is formed of a resin composition including 100 parts by weight of polystyrene and 5 to 30 parts by weight of maleic anhydride.

### CROSS-REFERENCE TO RELATED APPLICATIONS

This application claims the priority of Korean Patent Application No. 10-2012-0005142 filed on Jan. 17, 2012, in the Korean Intellectual Property Office, the disclosure of which is incorporated herein by reference.

### BACKGROUND OF THE INVENTION

1. Field of the Invention

The present invention relates to a bio-chip, and more particularly, to a bio-chip having excellent measurement efficiency and measurement precision.

2. Description of the Related Art

Demands for a bio-medical instrument and/or biological techniques to rapidly diagnose different human diseases have recently increased. Accordingly, for the replacement of conventional medical examinations or tests for specific diseases implemented in existing hospitals or laboratories, requiring a relatively long period of time, the development of a bio-sensor or bio-chip capable of providing test results in a short period of time has been actively undertaken.

A bio-sensor or bio-chip is a device required not only in hospitals, but also in other institutions such as pharmaceutical companies, cosmetic firms, and the like. In such pharmaceutical and/or cosmetic institutions, an examination method for testing a cellular reaction to a specific drug in order to assess or verify the efficacy and safety (or toxicity) thereof is used. However, existing testing methods necessarily require the use of an animal test subject or a large amount of reagent, thus leading to high costs and/or a relatively long period of time required for experimentation.

Accordingly, the development of a novel bio-sensor or bio-chip enabling rapid and accurate diagnoses while reducing costs therefor is required.

The bio-chip may include a DNA chip, a protein chip and a cellular chip, in terms of the types of bio-materials fixed to a substrate. In the early years of bio chips, on the basis of the search to understand human genetic information, DNA chips received considerable attention. However, since proteins, as the basis of the activity of living tissues, and cells composed of combined proteins, as a major part of living organisms, have gradually drawn a great deal of interest, protein chips and cellular chips are currently receiving a large amount of interest.

Although early difficulties were experienced in the development of protein chips, due to the problem of non-selective adsorption, several noticeable results regarding the foregoing problem have recently been reported.

However, cellular chips are an effective medium which may facilitate a variety of applications, such as the development of novel drugs, genomics, proteomics, etc. and are attracting a great deal of public attention.

### SUMMARY OF THE INVENTION

An aspect of the present invention provides a bio-chip having excellent measurement efficiency and measurement precision.

According to an aspect of the present invention, there is provided a bio-chip including; a first substrate including a plurality of micro-pillars protruded from one surface thereof to a predetermined height and having a biomaterial adhered to protruded surfaces of the plurality of micro-pillars, wherein the first substrate is formed of a resin composition including 100 parts by weight of polystyrene and 5 to 30 parts by weight of maleic anhydride.

The first substrate may be formed by injection molding the resin composition.

The resin composition may include a copolymer of polystyrene and maleic anhydride.

The resin composition may include 20 to 40 parts by weight of butadiene, with respect to 100 parts by weight of polystyrene.

The biomaterial may be adhered to the protruded surfaces of the plurality of micro-pillars by a porous dispersing material.

The plurality of micro-pillars may have a fixing material formed on the protruded surfaces thereof in order to fix the biomaterial to the protruded surfaces.

The plurality of micro-pillars may have a fixing material formed on the protruded surfaces thereof in order to fix the biomaterial to the protruded surfaces and the biomaterial may be adhered to the protruded surfaces of the plurality of micro-pillars by a porous dispersing material.

The fixing material may include a gelling material to allow the dispersing material to become a gel.

The bio-chip may further include a second substrate coupled to the first substrate and having a plurality of micro-wells, into which the plurality of micro-pillars of the first substrate are inserted.

The second substrate may be formed by injection molding a resin composition.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view illustrating a first substrate configuring a bio-chip according to an embodiment of the present invention;

FIG. 2 is an enlarged perspective view illustrating a part of the first substrate configuring a bio-chip according to the embodiment of the present invention;

FIG. 3 is an enlarged cross-sectional view illustrating a part of the first substrate configuring a bio-chip according to the embodiment of the present invention;

FIG. 4 is a schematic view illustrating a method of manufacturing the first substrate according to the embodiment of the present invention by injection molding a resin composition;

FIG. 5 is a schematic perspective view illustrating a second substrate according to the embodiment of the present invention; and

FIG. 6 is a schematic cross-sectional view illustrating functions of the first and second substrates in the bio-chip according to the embodiment of the present invention.

### DETAILED DESCRIPTION OF THE EMBODIMENTS

Embodiments of the present invention will now be described in detail with reference to the accompanying drawings. The embodiments of the present invention may be modified in many different forms and the scope of the invention should not be limited to the embodiments set forth herein. Rather, these embodiments are provided so that this disclosure will be thorough and complete, and will fully convey the concept of the invention to those skilled in the art. In the drawings, the shapes and dimensions may be exaggerated for clarity, and the same reference numerals will be used throughout to designate the same or like components.

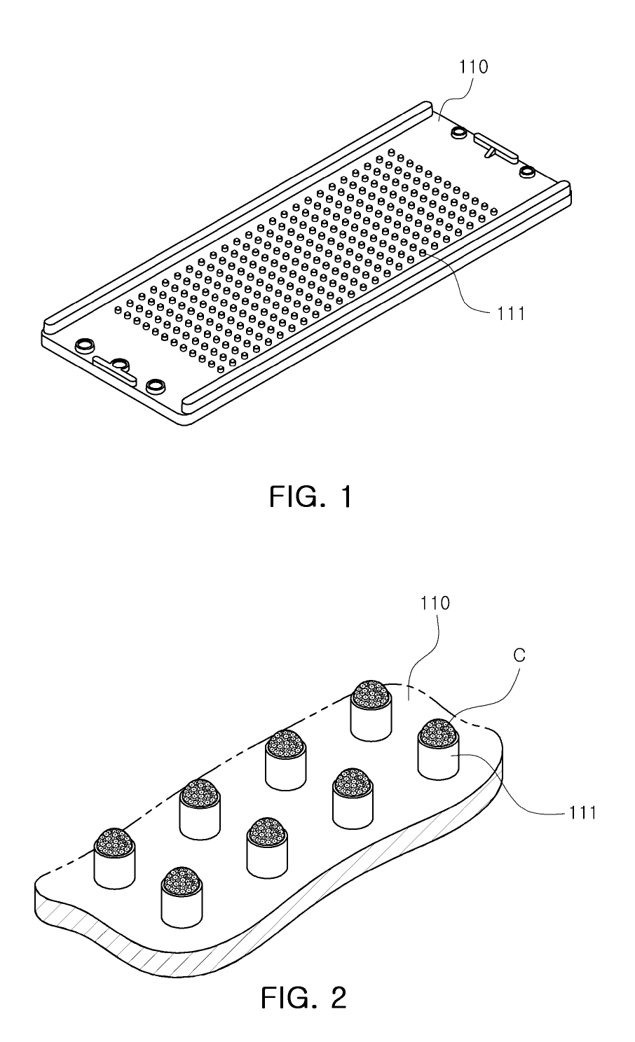

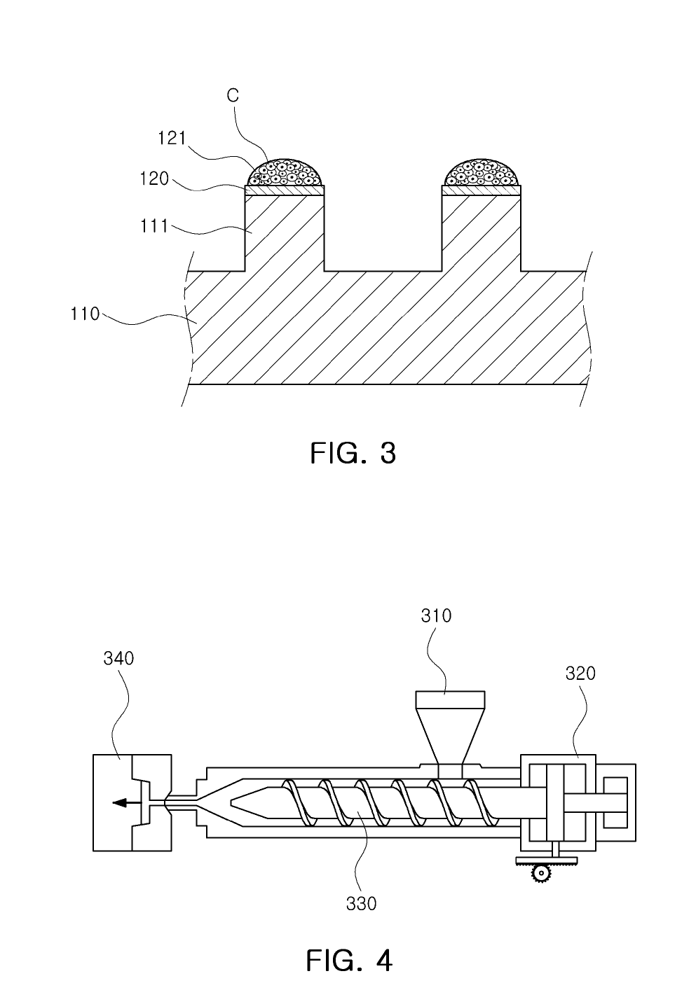

FIG. 1 is a schematic perspective view illustrating a first substrate configuring a bio-chip according to an embodiment of the present invention. FIG. 2 is an enlarged perspective view illustrating a part of the first substrate configuring a bio-chip according to the embodiment of the present invention. FIG. 3 is an enlarged cross-sectional view illustrating a part of the first substrate configuring a bio-chip according to the embodiment of the present invention.

Referring to FIGS. 1 through 3, the bio-chip according to an embodiment of the present invention may include a first substrate 110. The first substrate 110 may have a plurality of micro-pillars 111 formed thereon.

The micro-pillars 111 may refer to structures protruding from one surface of the first substrate 110 to a predetermined height and may be understood as fine rods or fine pins. More particularly, the micro-pillars 111 are three-dimensional structures and biomaterials C may be adhered to protruded surfaces of the micro-pillars 111.

The micro-pillars 111 may have different heights and, for example, may have a height ranging from 50 to 1000 μm, without being particularly limited. In addition, the shape of the cross-sections and/or protruded surfaces of the micro-pillars 111 is not particularly limited. The micro-pillars 111 may be provided in a matrix form on the first substrate 110.

The biomaterials C are not particularly limited in terms of types thereof and may refer to, for example, nucleic acid sequences such as RNA, DNA, or the like; peptides; proteins; lipids; organic or inorganic chemical molecules; virus particles; prokaryotic cells; cell organelle, or the like. In addition, the types of cells are not particularly limited but may include, for example, microorganisms; animal and/or plant cells; cancer cells; nerve cells; intravascular cells; immune cells, and so forth.

According to the embodiment of the present invention, the biomaterials C may be dispersed in a dispersing material 121 capable of maintaining a state of tissues of the biomaterials and functions thereof and be adhered to the protruded surfaces of the micro-pillars 111.

The dispersing material 121 may be formed of a porous material through which culture media, specific drugs and/or reagents such as a variety of aqueous solutions may permeate. The dispersing material 121 may be, for example, a sol-gel, a hydro-gel, an alginate gel, an organogel, a xerogel, gelatin, collagen, or the like, without being particularly limited.

According to the embodiment of the present invention, the biomaterials C may be dispersed in the dispersing material 121 and then adhered to the protruded surfaces of the micro-pillars 111 while having a three-dimensional structure. The environment of the biomaterial C having the three-dimensional structure is substantially similar to that of a living body, to thereby allow for more precision to be obtained in test results.

According to the embodiment of the present invention, fixing materials 120 may be formed on the protruded surfaces of the micro-pillars 111 in order to fix the biomaterials to the protruded surfaces. The fixing material 120 is not particularly limited but may include, for example, polyethyleneimine, polylysine, polyvinylamine, polyarylamine, fibronectin, gelatin, collagen, elastine, laminin, or the like and may be provided as a mixture thereof.

Further, the fixing material 120 may include a gelling material to allow the dispersing material 121 to become a gel. The gelling material is not particularly limited but may include, for example, BaCl₂, palladium acetate, N,N′-bis(salicylidene)pentamethylenediamine, potassium phosphate, and/or the like and may be provided as a mixture of at least one thereof.

The first substrate 110 may be formed of a resin composition. The resin composition may include polystyrene and maleic anhydride.

According to the embodiment of the present invention, the first substrate 110 may be formed by injection molding the resin composition.

The resin composition may include 5 to 30 parts by weight of maleic anhydride with respect to 100 parts by weight of polystyrene.

According to the embodiment of the present invention, in order to form the micro-pillars as fine structures on the first substrate 110, fluidity of the resin composition needs to be appropriately controlled.

If a content of polystyrene is high, an adhesion rate of the biomaterials C to the micro-pillars may be reduced. If the content of polystyrene is low, fluidity may be deteriorated, in turn reducing formability, to thus cause a defect in manufacturing the first substrate having the micro-pillars formed thereon.

Maleic anhydride has excellent binding ability to the biomaterials. If a content of maleic anhydride is less than 5 parts by weight, adhesion between the micro-pillars of the first substrate and the biomaterial may be decreased. On the other hand, if the content of maleic anhydride exceeds 30 parts by weight, formability of the first substrate may be reduced.

According to the embodiment of the present invention, the content of maleic anhydride may be controlled, whereby the biomaterials may be securely adhered to the protruded surfaces, without being detached therefrom. In addition, as described above, according to the embodiment of the present invention, the fixing materials 120 may be formed on the protruded surfaces of the micro-pillars 111 and maleic anhydride may have improved adhesion with fixing materials 120.

FIG. 4 is a schematic view illustrating a method of manufacturing the first substrate according to the embodiment of the present invention by injection molding a resin composition.

Referring to FIG. 4, a hopper 310 may be supplied with the resin composition. The resin composition may include 100 parts by weight of polystyrene and 5 to 30 parts by weight of maleic anhydride, as described above. The resin composition supplied to the hopper 310 is mixed in a cylinder 320 to be transferred to a front end of the cylinder 320 through a screw 330. During the transfer, the resin composition may be uniformly plasticized. When a certain amount of the resin composition is accumulated at the front end of the screw 330, the screw 330 is stopped and the melted resin composition may be injected by the cylinder 320 into a closed mold 340 at high pressure. The mold 340 may be the first substrate having a plurality of micro-pillars formed thereon, as shown in FIG. 1.

Without particular limitations, the first substrate according to the embodiment of the present invention may be manufactured by various injection molding methods.

According to the embodiment of the present invention, maleic anhydride may be included in the resin composition, in the form of a copolymer of polystyrene and maleic anhydride (polystyrene-co-maleic anhydride). Based on the content of maleic anhydride included in the polystyrene-co-maleic anhydride copolymer, the amount in which the polystyrene-co-maleic anhydride is added may be controlled. Even in a case in which maleic anhydride is added in the form of the polystyrene-co-maleic anhydride copolymer, the content of maleic anhydride may range from 5 to 30 parts by weight.

In a case in which the polystyrene-co-maleic anhydride copolymer is mixed with polystyrene, fluidity and injection properties may become superior. Without particular limitations, the polystyrene-co-maleic anhydride copolymer may include 22% maleic anhydride.

The polystyrene-co-maleic anhydride (PSMA) copolymer including 22% maleic anhydride (MA) is mixed with polystyrene (PS) to be injection molded, thereby manufacturing the first substrate having micro-pillars formed thereon, and a detachment rate of biomaterials is measured. Measured results are shown in Table 1. In a case in which at least two biomaterials are detached from the first substrate having the micro-pillars formed thereon, the case is considered to have a defect. Referring to the following Table 2, a content ratio of PSMA including 22% MA was controlled, such that a defect such as the biomaterials being detached (that is, detached) from the micro-pillars was not generated.

TABLE 1

| | PS | Defect rate | Defect rate | Defect rate | Defect rate |
|---|---|---|---|---|---|
| PSMA | con- | in Experi- | in Experi- | in Experi- | in Experi- |
| content | tent | mentation 1 | mentation 2 | mentation 3 | mentation 4 |
| 40% | 60% | 0% | 0% | 0% | 0% |
| 50% | 50% | 0% | 0% | 0% | 0% |

Further, according to the embodiment of the present invention, the resin composition for manufacturing the first substrate may include butadiene. A content of the butadiene (included in the resin composition) may range from 20 to 40 parts by weight, with respect to 100 parts by weight of polystyrene. In the case in which butadiene is added to the resin composition, formability of the first substrate may be excellent.

In addition, according to the embodiment of the present invention, in order to facilitate the mixing of maleic anhydride and polystyrene, an additive may be included.

The bio-chip according to the embodiment of the present invention may further include a second substrate having micro-wells formed therein.

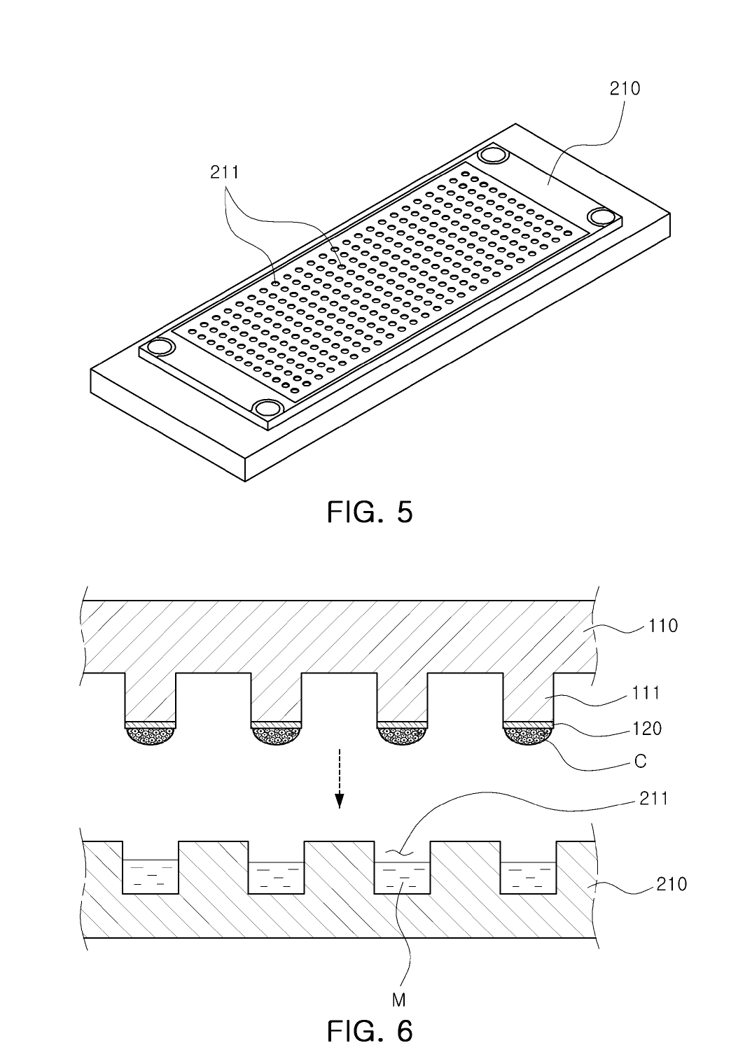

FIG. 5 is a schematic perspective view illustrating a second substrate according to the embodiment of the present invention. FIG. 6 is a schematic cross-sectional view illustrating functions of the first and second substrates in the bio-chip according to the embodiment of the present invention.

Referring to FIGS. 5 and 6, the second substrate 210 according to the embodiment of the present invention may include a plurality of micro-wells 211 arranged at predetermined intervals. The micro-wells 211 may be formed to have a predetermined depth from one surface of the second substrate and may be fine grooves.

The micro-wells 211 may each have a diameter on a micro scale. Without particular limitations, the diameter of each micro-well 211 may range from 50 to 1200 μm. Also, the micro-wells 211 may be highly integrated on the second substrate 210 and a gap between the micro-wells may range from 50 to 1500 μm without being particularly limited.

The micro-wells 211 may have reagents M introduced thereto. Such a reagent M is not particularly limited and may be, for example, a cell culture medium, a specific drug, or any one of various aqueous solutions.

The second substrate 210 may be formed of a resin composition. The resin composition may include, for example, polymethylmethacrylate (PMMA), polycarbonate (PC), polyethylene, polystyrene, maleic anhydride, or the like, without being particularly limited and may be provided as a mixture thereof. In addition, as described above, the second substrate 210 may be formed of the resin composition the same as that of first substrate 110. Moreover, the second substrate 210 may be formed by injection molding.

In the case in which the second substrate 210 is manufactured by injection molding the resin composition the same as that of the first substrate 110, the second substrate having micro-wells as fine structures may be more easily manufactured.

As shown in FIG. 6, when the first substrate 110 is coupled to the second substrate 210, the biomaterials C adhered to the micro-pillars 111 of the first substrate 110 may be inserted into the micro-wells 211 formed in the second substrate 210. The reagents M contained in the micro-wells 211 may be supplied to the biomaterials C.

In order to maintain the functions of the biomaterials C, a culture medium needs to be continuously supplied to the biomaterials C. Also, in order to measure a reaction of the biomaterials C to a specific drug, the specific drug needs to be supplied to the biomaterial C. Toxicity tests for the development of a novel drug, sensitivity and resistance tests to an anti-cancer agent, and the like may be performed through the supply of the specific drug.

When the micro-pillars 111 are inserted into the micro-wells 211, a variety of reagents may be directly supplied to the biomaterials C. The biomaterials C are formed on the micro-pillars 111, to thereby enhance a combination rate of the biomaterials C and the reagents M. Accordingly, cell culturing may be possible and a variety of experiments may be performed by analyzing characteristics of biomaterials using the reagents.

According to the embodiment of the present invention, the biomaterials and the micro-wells may be highly integrated on the first substrate or the second substrate. Since the biomaterials are arranged to be highly integrated, various diagnoses may be simultaneously performed and the precision of experimental results thereof may be increased. Also, various kinds of biomaterials may be formed and concurrently subjected to experimentation or the diagnosis of characteristics thereof with respect to the same drug. According to the embodiment of the present invention, the constituents of the resin composition and contents thereof may be controlled, the first substrate including micro-pillars as fine structures formed thereon may be easily fabricated. In addition, the biomaterials formed on the protruded surfaces of the micro-pillars having a small area exhibits excellent adhesiveness, to thereby improve the efficiency of both experimentation and diagnosis.

The bio-chip according to the embodiment of the present invention includes the first substrate and the second substrate, such that the first and second substrates may be separated from each other and independently washed. The culture medium and the reagent contained in the micro-well may be periodically replaced.

In the bio-chip according to the embodiment of the present invention, the biomaterials may be adhered to the micro-pillars as protruded structures to be easily washed out after drug treatment thereof.

As set forth above, the embodiment of the present invention, a first substrate may be formed using a resin composition.

According to the embodiment of the present invention, the first substrate having micro-pillars as fine structures formed thereon may be formed by controlling constituents of the resin composition and contents thereof.

According to the embodiment of the present invention, fluidity, formability and injection properties of the resin composition are adjusted, such that the first substrate having the micro-pillars formed thereon may be easily manufactured by injection molding.

According to the embodiment of the present invention, the first substrate may include maleic anhydride, thereby enabling biomaterials to be properly adhered to micro-scaled protruded surfaces, without detachment therefrom. In addition, according to the embodiment of the present invention, fixing materials may be formed on the protruded surfaces of the micro-pillars and maleic anhydride may have improved adhesion with the fixing materials.

Further, according to the embodiment of the present invention, the biomaterials may be dispersed in a dispersing material and adhered to the protruded surfaces of the micro-pillars while having a three-dimensional structure. The environment of the biomaterials having a three-dimensional structure is substantially similar to that of a living body, to thereby allow for more precision to be obtained in test results.

According to the embodiment of the present invention, the biomaterials and the micro-wells may be highly integrated on the first substrate or the second substrate. Since the biomaterials are arranged to be highly integrated, various diagnoses may be simultaneously performed and the precision of experimental results thereof may be increased. Also, various kinds of biomaterials may be formed and concurrently subjected to experimentation or the diagnosis of characteristics thereof with respect to the same drug.

The bio-chip according to the embodiment of the present invention may include the first substrate and the second substrate, such that the first and second substrates may be separated from each other and the culture medium and the reagents contained in the micro-wells may be periodically replaced.

In the bio-chip according to the embodiment of the present invention, the biomaterials may be adhered to the micro-pillars as protruded structures to be easily washed out after drug treatment thereof.

While the present invention has been shown and described in connection with the embodiments, it will be apparent to those skilled in the art that modifications and variations can be made without departing from the spirit and scope of the invention as defined by the appended claims.

1. A bio-chip comprising:
a first substrate including a plurality of micro-pillars protruded from one surface thereof to a predetermined height and having a biomaterial adhered to protruded surfaces of the plurality of micro-pillars, wherein:
the first substrate is formed of a resin composition including 100 parts by weight of polystyrene and 5 to 30 parts by weight of maleic anhydride,
the plurality of micro-pillars have a fixing material formed on the protruded surfaces thereof in order to fix the biomaterial to the protruded surfaces, and
the fixing material is polylysine.

2. The bio-chip of claim 1, wherein the first substrate is formed by injection molding the resin composition.

3. The bio-chip of claim 1, wherein the resin composition includes a copolymer of polystyrene and maleic anhydride.

4. (canceled)

5. The bio-chip of claim 1, wherein the biomaterial is adhered to the protruded surfaces of the plurality of micro-pillars by a porous dispersing material.

6. (canceled)

7. The bio-chip of claim 1, wherein the plurality of micro-pillars have a fixing material formed on the protruded surfaces thereof in order to fix the biomaterial to the protruded surfaces and the biomaterial is adhered to the protruded surfaces of the plurality of micro-pillars by a porous dispersing material.

8. The bio-chip of claim 7, wherein the fixing material includes a gelling material to allow the dispersing material to become a gel.

9. The bio-chip of claim 1, further comprising a second substrate coupled to the first substrate and having a plurality of micro-wells, into which the plurality of micro-pillars of the first substrate are inserted.

10. The bio-chip of claim 9, wherein the second substrate is formed by injection molding a resin composition.
